(19) United States
(12) Patent Application Publication
(10) Pub. No.: US 2022/0415100 A1
(43) Pub. Date: Dec. 29, 2022

(54) SYSTEM AND DETECTION DEVICE FOR CHECKING A STATE OF AT LEAST ONE COMPONENT OF A VEHICLE AND METHOD OF CHECKING A STATE

(71) Applicant: SAF-HOLLAND GmbH, Bessenbach (DE)

(72) Inventor: Mark Hartmann, Heigenbrücken (DE)

(73) Assignee: SAF-HOLLAND GmbH, Bessenbach (DE)

(21) Appl. No.: 17/756,682

(22) PCT Filed: Dec. 1, 2020
(86) PCT No.: PCT/EP2020/084137

§ 371 Date: May 31, 2022

(30) Foreign Application Priority Data
Dec. 5, 2019 (DE) 10 2019 133 172.2

(51) Int. Cl. G07C 5/08; G07C 5/00

(52) U.S. Cl. CPC G07C 5/0808; G07C 5/0816; G07C 5/008

(57) ABSTRACT

A system and method for checking the state of at least one component on a vehicle, in particular on a commercial vehicle, comprising a detection device configured to detect information in the form of a data set in a defined area on the vehicle, the defined area comprising the at least one component to be checked, and an evaluation device to which the data set is provided, wherein the evaluation device is configured to determine the state of the at least one component on the basis of the detected data set, and wherein the detection device is at least temporarily attached to the vehicle and/or can be carried along on the vehicle.

### BACKGROUND OF THE INVENTION

The present invention relates to a system for checking a state of at least one component of a vehicle, a detection device for the system and a method for checking a state.

It is known from the prior art that a vehicle can travel without a driver in the context of autonomous driving. For example, the vehicle may be a commercial vehicle, in particular a truck. Up to now, safety-relevant and load-bearing parts of the vehicle have typically been checked by a driver, for example by visual inspection, before the vehicle is driven. If the driver is not present, this task must be carried out by an additional person. Furthermore, the state of the art knows devices that automatically or actively send signals or information about the current state of a component. DE 10 2004 006 295 B4 discloses a device for monitoring a physical parameter of a wheel mounted on a vehicle, the device being mounted on the wheel. DE 10 2016 012 052 A1 relates to a device for departure control for a vehicle with an external video system for detecting and storing image data of the vehicle. According to various legal regulations (e.g. BGG 915 of the German Social Accident Insurance), the lighting, wheels, brakes, engine and drive, steering, driver's cab and fittings, body, load securing and trailer operation, among others, must be tested before driving off.

In order to be able to realise autonomous driving to the full extent, it is therefore an object of the invention to find a way to be able to carry out the check fully automatically before driving and also to be able to detect possible technical problems automatically at an early stage during the journey. The system used should be as cost-effective and material-saving as possible.

### SUMMARY OF THE INVENTION

According to a first aspect of the present invention, a system for checking a state of at least one component on a vehicle is provided, in particular on a commercial vehicle, comprising

a detection device which detects information in the form of a data set in a defined area on the vehicle, the defined area comprising the at least one component to be checked, and

an evaluation device to which the data set is provided, wherein the evaluation device is configured to determine the status of the at least one component on the basis of the detected data set, wherein the detection device is attached to the vehicle and/or can be carried along on the vehicle at least temporarily. In contrast to the systems known from the prior art for checking the state of components, it is provided in accordance with the invention to detect information in a defined area on the vehicle. In this way, for example, several components can be checked within the scope of a departure check. The collected information can then be forwarded in the form of a data set, preferably via wireless transmission, to an evaluation device and analysed there. Alternatively, the data can also be forwarded via cable. The evaluation device comprises, for example, a computer which is designed to determine the state of the checked component on the basis of the detected data set. The evaluation device can be integrated into the vehicle or into an external control centre. If the data set includes an optically detected image, for example, a comparison can be made with one or more target images in order to assess the state of the component. In this way, the departure check can be carried out fully automatically. Alternatively, it can also be carried out remotely by a person or at least partially monitored by a person, for example in the form of a partially automated departure check. Since the detection device can be carried along with the vehicle, a departure check is possible at any location and, in particular, independent of measuring devices or personnel present at the departure location. It is preferably provided that at least during a detection of the data set there is a distance of at least 10 cm, preferably at least 30 cm and particularly preferably at least 50 cm between the detection device and the defined area, at least temporarily, preferably always. The detection device is thus advantageously spaced apart from the defined area.

The detection device preferably comprises a sensor based, for example, on the detection and/or emission of electromagnetic waves and/or sound waves. This can be, for example, a video camera that collects information in the form of optical detections, preferably in the form of one or more images, of a defined area in or on the vehicle and thus detects, for example, one or more components of the vehicle. A detected image can then preferably be processed with the aid of an image evaluation program of the evaluation device and, for example, be compared with a target image in order to determine changes in the area or on one or more components. However, measurements in the infrared spectral range with the aid of infrared sensors are also conceivable, for example to check the temperature of one or more components and to detect overheating in good time. It is conceivable to monitor the temperature of the brake discs in this way. Other conceivable sensors could include light sensors, radar sensors, laser-based measuring arrangements, ultrasonic sensors and microphones. Microphones can be used to monitor noise during vehicle operation, for example to detect engine stuttering at an early stage. However, other types of sensors are also conceivable. For example, temperature measuring devices such as resistance thermometers or thermocouples can be used to check the temperature of one or more components. A pressure sensor is also conceivable, which can be used, for example, to check the tyre pressure. Strain gauges can be used to detect deformations of components such as the body. The use of a Hall probe is also conceivable, for example to check the shielding of electrical cables or voltage converters in the vehicle, especially in an electric vehicle. Strong magnetic fields could, for example, have a negative effect on the vehicle's control electronics. In principle, it is also conceivable that the detection device consists of several sensors, in particular a combination of different sensors is also possible. The comparison of the measured values of different sensors can provide a higher level of safety. In addition, a more detailed analysis of a component can be made possible. For example, it could be detected if a component has deformed due to overheating by simultaneously monitoring the shape and the temperature of the component. It is particularly preferred that the detection device comprises a data collection device that is in contact with several sensors and collects the information from the sensors and forwards it to the evaluation device. The data collection device can, for example, be at a distance from the sensors, for example at least 10 cm, preferably at least 20 cm and particularly preferably at least 50 cm.

It is expedient that the detection device is mobile and/or pivotable, preferably about one, two or three axes, and/or movable and/or positionable. For example, the detection device, in particular the data collection device, can be positioned on a moving means. It is also conceivable that the detection device is mounted in a fixed position and can be pivoted, preferably about one, two or three axes, in order to detect different areas. It is particularly preferred that the detection device is both changeable in location and pivotable. In this way, by means of corresponding orientations of the detection device, areas which are distant from one another and which are to be detected can also be examined with a detection device, in particular a single detection device.

The detection device, in particular the moving means, can be, for example, a mobile or flying drone, a carriage on a rail system, a pivot arm, which can optionally also be telescoped, and/or a support body, which is attached, for example, to traction and/or guide cables. In this way, a drone can be attached to the vehicle when not in use, for example, and can only be activated for use when required, thus saving energy. Advantageously, it is conceivable that the detection device and/or the moving means comprise a drive. This drive can be electric, pneumatic, hydraulic and/or mechanical. Due to the mobility, the detection device can advantageously be used at several locations. This can save costs, among other things, since fewer detection devices are needed overall to cover all relevant components of the vehicle. Preferably, the rail system extends in the longitudinal direction of the vehicle. For example, the rail system is attached to an upper side and/or lower side of a trailer. In this case, the rail system is preferably arranged centrally and/or on edge regions of the upper side and/or underside of the vehicle, in particular of the trailer, as seen in the transverse direction.

Preferably, the detection device detects several defined areas, each defined area comprising at least one component to be checked. On the one hand, this can be made possible by mobility or changeability of location of the detection device. On the other hand, the detection device can also be rotatable or pivotable and thus cover, i.e. detect, several areas from one location. By “detection” is preferably meant the recording or reception of a data set. Alternatively, it is also conceivable that the detection device covers several areas lying one behind the other or next to each other and detects a different area in each case, for example by changing the focus and/or filtering out parts of the detected information.

Preferably, the detection device is at least temporarily positioned outside the vehicle and/or on the outside of the vehicle. This makes it possible in an advantageous way to also check external components of the vehicle, such as one or more tyres, locking mechanisms or the external chassis.

Preferably, the at least one component to be detected is part of a body and/or part of a chassis and/or part of a drive and/or part of a connection system of the vehicle. The body may include a bodyshell (doors, bonnet and bonnet), a cab, glazing, seals, door locks, windscreen wipers, lighting, bumpers, instruments, seats, e.g. for passengers, interior trim, heating and air conditioning and one or more batteries. These components can be checked, for example, by optical sensors to detect damage, such as deformations or cracks, or defective lighting equipment, such as defective headlights or direction indicators. Heating and air conditioning, on the other hand, could be checked by infrared sensors, for example. The running gear comprises a chassis, also known as a frame, rims, tyres and wheels, wheel guidance, suspension, brakes and steering. The components of the chassis can also be visually checked for damage, for example. In addition, the temperature of individual components, in particular the brakes, can be detected by an infrared sensor, for example. The drive comprises a motor, motor cooling, energy storage as well as a torque converter with clutch and gearbox. The connection system includes one or more locking devices, such as door locks, load securing, trailer/semitrailer operation and coupling. Here, for example, it can be checked whether doors or other locking devices are properly locked in order to prevent loss of a load, for example by falling down or theft. The correct connection of trailers or successful coupling can also be checked. Advantageously, these components can be checked by one or more detection devices positioned inside and outside. The electrics or electronics located in or on the listed vehicle parts can also be checked. Thus, for example, all relevant components can be checked during a departure check.

Preferably, the detection device is designed to be able to check the state of one or more components while the vehicle is in motion. This makes it possible to detect problems such as defective components or components that may soon become defective due to advanced wear. Especially in the absence of a driver in autonomous driving vehicles, this possibility to monitor components while driving is helpful to avoid accidents. For example, the temperature of the brakes can be monitored with an infrared camera. In particular, it is also conceivable that a single moving infrared camera can monitor the temperatures of all brakes and thus replace several individual sensors. Damage caused by environmental influences, such as collisions with other vehicles or parts falling on the vehicle during a storm, for example branches or stones, can also be registered quickly.

Advantageously, the data set detected by the detection device can be stored in a memory device. The memory device can, for example, be based on magnetic or electronic storage. Conceivable are, among others, hard disk drives or semiconductor memories, such as flash memories, memory cards, USB sticks or SSDs. Stored data can serve, for example, as proof of a proper departure check and/or of the state of the vehicle at the start of the journey. Stored data sets can also be used for comparison with newly detected data sets, in order to be able to register a change in the components, e.g. due to wear, in this way. In this way, components in need of repair can be identified in good time and, advantageously, even before a final defect.

Preferably, the system comprises a communication device by means of which information concerning the state of a component can be transmitted to a control centre. There, for example, information about several vehicles can be collected and possibly also processed. This makes it easier, for example, to organise the necessary repairs and/or spare parts. It is also conceivable that, based on the state of its checked components, a vehicle can be given new commands if necessary, such as to abort a journey and return to a fleet or to a repair workshop.

Advantageously, the communication device is connected to a network. The connection can, for example, run via the control centre. Alternatively, it is also conceivable that the communication device is directly connected to a network. For example, a connection can be established with a stationary hub or a direct connection with other vehicles in the vicinity. This makes it conceivable, for example, that in the event of problems with individual or several components, a warning is transmitted to other vehicles in order to avoid accidents. Problems could be, for example, brakes that fail or do not function properly for a short time, locking devices that open unintentionally (whereby, for example, transport goods could fall down) or a defective trailer coupling. For example, a hub could be used to automatically contact a service station in order to request repairs, for example.

Preferably, the detection device is at least partially, preferably completely, in a locked area during a rest state. A locked area may be, for example, a lockable container such as a chamber, capsule or small garage attached to or forming part of the vehicle. For example, a mobile or flying drone with a detection device may be parked in a locked area while not in use. It is also possible to have a projection on the vehicle into which, for example, a pivot arm to which a detection device is attached is lowered when not in use. Optionally, the projection may also have a locking mechanism, such as a flap or a sliding or rotating lock. By remaining in the enclosed area, the detection device can be protected from environmental influences or from unauthorised access by third parties. Energy can also be saved, particularly in the case of drones, by parking in a locked area.

Another aspect of the present invention is a detection device for a system according to the invention. All the advantages and features described for the system can be transferred analogously to the detection device and vice versa.

A further aspect of the present invention is a method for determining a state of at least one component of a vehicle, in particular a commercial vehicle, having a system for checking a state of at least one component on a vehicle, in particular on a commercial vehicle, comprising the steps of

(a) detecting information in the form of a data set by means of a detection device, the information being present in a defined area, preferably in a plurality of defined areas, on the vehicle, the defined area comprising the at least one component to be checked,
(b) providing the data set to an evaluation device; and
(c) determining the state of the component by means of the detected data set by the evaluation device, wherein the detection device is attached to the vehicle and/or can be carried along on the vehicle at least temporarily. All the advantages and features described for the system can be transferred analogously to the method and vice versa.

### BRIEF DESCRIPTION OF THE DRAWINGS

Further advantages and features result from the following description of preferred embodiments of the object according to the invention with reference to the attached figures. It shows:

FIG. 1 is a commercial vehicle with a system for checking several components of the commercial vehicle according to a first exemplary embodiment of the present invention;

FIG. 2 is a commercial vehicle with a system for checking several components of the commercial vehicle according to a second exemplary embodiment of the present invention;

FIG. 3 is a view of the underside of a vehicle with a system for checking a plurality of wheels or a plurality of brakes of the vehicle with a detection device according to a third exemplary embodiment of the present invention; and

FIG. 4 is a schematic representation of an example of a method according to the present invention.

### DETAILED DESCRIPTION OF THE PREFERRED EMBODIMENTS

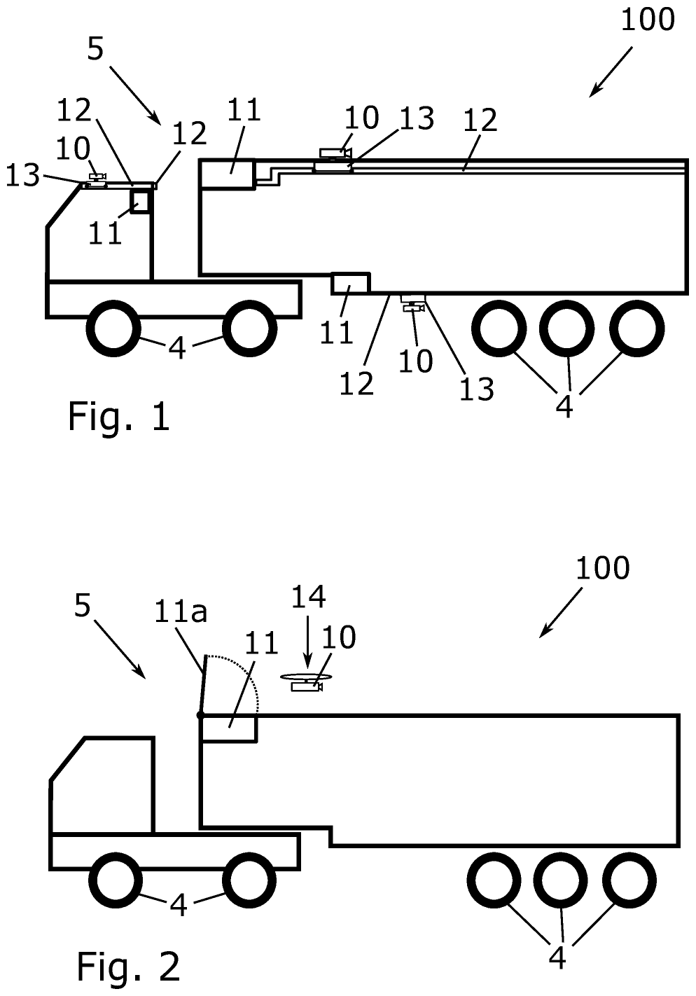

FIG. 1 shows a vehicle 5 with a system 100 for checking a status of a component on the vehicle 5 according to a first exemplary embodiment of the present invention. The vehicle 5 shown here is an articulated lorry on which a plurality of detection devices 10 are mounted on carriages 13 and can move on a rail system 12. In the illustration shown, the detection devices 10 are located on the outside of the vehicle 5, but it is also possible that detection devices 10 are additionally or exclusively located inside the vehicle 5. The detection devices 10 shown are only intended to serve as an example and are not to be understood as restrictive, in particular with regard to the shape and placement of the detection devices 10. The detection devices 10 in this example are designed to check the external components of the vehicle 5. In particular, the detection devices 10 can each check a plurality of defined areas on the exterior of the vehicle 5, in particular on the body and chassis of the vehicle 5, through the rail system 12. It is also optionally possible to rotate the detection devices 10 on the carriage 13 in order to check components located in different defined areas by changing the angle of view of the detection device 10. For example, locking devices such as doors and tailgates can be checked, which can be done with optical sensors, for example. A functional check of the lighting equipment of the vehicle 5 can also be carried out by light sensors. It is also possible for a detection device 10 on a carriage 13 to comprise different sensors in order to check different components with the appropriate sensor as required, for example by optical image detection to check a locking device and by light sensor to check the lighting device. Furthermore, it can also be checked whether the trailer hitch (not shown) is properly coupled and whether a support leg (not shown) is retracted before driving off. Furthermore, the wheels 4 can be checked, for example, by optical image matching, in order to check the tyre profile. Furthermore, it is preferably provided that the detection device 10 is arranged on an upper side and/or underside of a trailer. For example, the rail system 12 extends more than 50%, preferably more than 70% and particularly preferably more than 80% of the longitudinal extent of the trailer in the longitudinal direction of the trailer. It is also conceivable that the rail system 12 comprises both longitudinal components and transverse components with which the detection device 10 is movable both in the longitudinal direction and in the transverse direction on or under the trailer.

The system is particularly suitable for departure control. Before and after the check, the detection devices 10 can each move via the rail system 12 to a designated closed area 11 in order to be put into a rest state there. This protects them from environmental influences and from unauthorised access by unauthorised persons. However, it is also possible for the detection devices 10 to be used continuously or intermittently during the journey. For example, a detection device 10 on the underside of the vehicle 5 could monitor the temperature of the brakes with the aid of an infrared camera. Due to the mobility, a detection device 10 with a sensor that can cover all areas with brakes is sufficient for this. While a quasi-continuous check is possible alternating between the brakes, the detection device 10 could also be activated at certain time intervals, thus saving energy. In general, it is also possible to have a system in which a detection device 10 is activated when necessary, for example to find the cause of an unexplained problem. For example, the brakes could be specifically checked if braking performance deteriorates, or the tyres 4 and axles could be checked if driving behaviour deteriorates. On the other hand, an additional sensor is also conceivable which prevents activation of the detection devices 10 in unfavourable external conditions and causes them to remain in or visit the enclosed area 11. For an optical sensor on the underside of the vehicle 5, unfavourable conditions could be, for example, a muddy surface that could lead to contamination of the optics.

FIG. 2 shows a vehicle 5 with a system 100 for checking a status of a component on the vehicle 5 according to a second exemplary embodiment of the present invention. The vehicle 5 shown here is an articulated lorry with a detection device 10 attached to a flying drone 14. Due to the high mobility, at least the complete exterior area of the vehicle 5 can be checked with a detection device 10 in this case. It is conceivable that the detection device 10 has two or more different sensors in order to be able to check different components appropriately. Alternatively, it would also be possible to have a mobile drone 14 that drives around or on top of the vehicle 5 and can thus check several defined areas. Also, optionally, another drone 14 is conceivable inside the vehicle 5 to check components in defined areas inside the vehicle 5. The drone 14 is connected to an evaluation device 20 in the vehicle 5 by a wireless connection. The wireless connection can be used to transmit information in the form of a data set 19 that is collected during checking the components. In addition or alternatively, there can also be a direct connection to a control centre outside the vehicle 5. The wireless connection can be based on WLAN, Bluetooth or mobile internet, for example. Advantageously, the drone 14 can carry out a check, such as a departure check, fully autonomously. However, it is also conceivable that the check is carried out remotely, for example from the control centre. In this embodiment, when the drone 14 is not in use, it is located in a closed area 11, which can be closed by a flap 11a. Alternatively, other closure mechanisms are possible, such as a sliding roof. In the enclosed area 11, the drone 14 is protected from external influences and energy can be saved in a rest state. In a preferred embodiment, a docking station is located in the enclosed area, at which the drone 14 can be charged with energy, e.g. via an electrical connection. A connection for data transmission is also optionally possible, at which, for example, updates for system software of the drone 14 can be transmitted. Optionally, the detected data set 19 can also be transmitted via a data connection. This can be useful, for example, if wireless transmission is not possible or not desired. In particular, a data port may also be an alternative option in the event that wireless transmission fails. In a further embodiment, the drone 14 may also be used at least temporarily during a journey of the vehicle 5 to check one or more components on the vehicle 5.

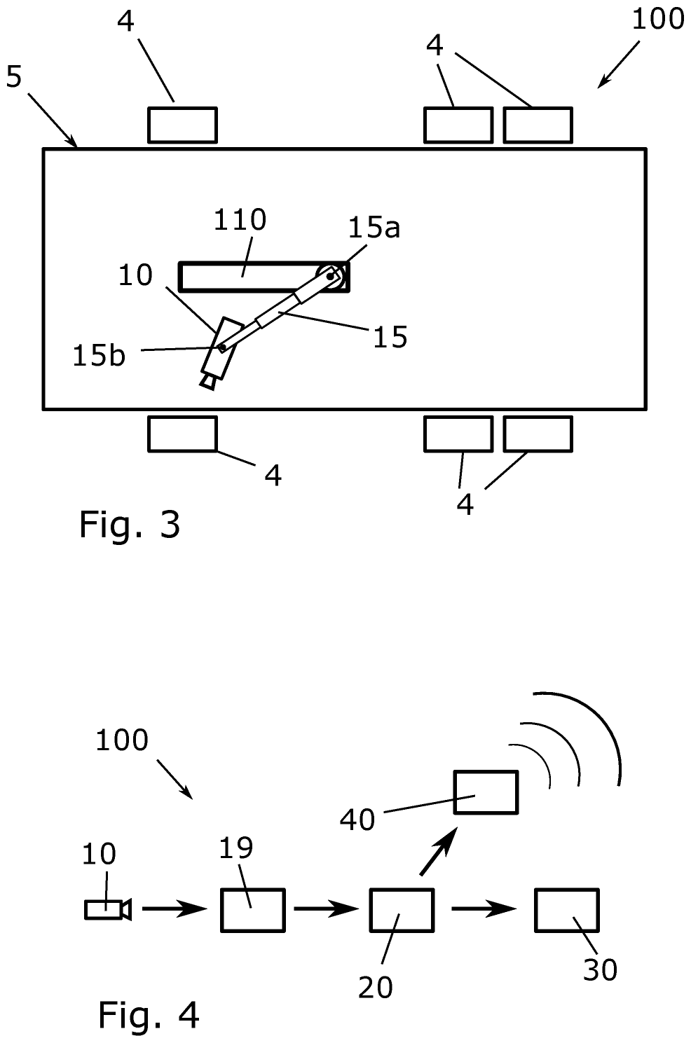

FIG. 3 shows a view of the underside of a vehicle 5 with a system 100 for checking a plurality of wheels 4 and/or a plurality of brakes of the vehicle 5 according to a third exemplary embodiment of the present invention. The vehicle 5 may be, for example, a commercial vehicle. It comprises a detection device 10, which is located on the underside of the vehicle 5. In this example, the detection device 10 is attached to a telescopic pivot arm 15 via a pivot axis 15b. The pivot arm 15 is in turn rotatably attached to the underside of the vehicle 5 by means of a pivot axis 15a. The detection device 10 comprises, for example, an infrared sensor with which the temperature of all brakes can be detected. In this way, a single sensor advantageously replaces several sensors. The tyre profile can also be checked with an optical camera, for example, or damage, such as cracks in the brake disc or a burst tyre, can be detected. In a rest state, the pivot arm 15 with the detection device 10 is lowered into a projection 110. Optionally, the projection 110 may comprise a locking mechanism, for example a sliding door. This protects the detection device 10 from external influences. The detection device 10 can be used, for example, at the start of a journey during a departure check or during an intermediate stop. Optionally, it can also be used during a journey.

FIG. 4 shows an example of a schematic representation of a method for determining a state of at least one component of a vehicle 5 with a system 100 according to the present invention. In a first step, a detection device 10 acquires information in the form of a data set 19, the information being available in a defined area, preferably in several defined areas, on the vehicle 5, the defined area comprising at least one component to be checked.

In a second step, the data set 19 is then made available to an evaluation device 20 via a wireless connection, alternatively also via a cable connection. In a third step, the evaluation device 20 determines the state of the component on the basis of the detected data set 19. The evaluation device comprises, for example, a computer or a microprocessor which is designed to determine the state of the checked component on the basis of the detected data set. The data set may now, in an optional fourth step, be stored on a memory device 30. The memory device 30 may be, for example, a hard disk or a flash memory. The stored data may be used, for example, as evidence of a departure check that has been carried out or as a comparison with data collected at a later time. In a further optional step, the data set 19 can be forwarded to a communication device 40, which transmits the data set 19 e.g. to a control centre. In this way, for example, a database of several vehicles 5 can be created. In addition, any repairs that may be necessary can be coordinated centrally.

### REFERENCE LIST

4 tyres
5 vehicle
10 detection device
11 closed area
11a flap
12 rail system
13 carriage
14 drone
15 pivot arm
15a rotation axis
15b rotation axis
19 data set
20 evaluation device
30 memory device
40 communication device
50 network
100 system
110 projection

1.-10. (canceled)

11. A commercial vehicle including a system configured to check the state of at least one component on the vehicle, the system comprising:
a mover;
a rail system;
a detection device configured to detect information in the form of a data set in a defined area on the vehicle, the defined area comprising the at least one component to be checked, the detection device positioned on an outside of the vehicle; and
an evaluation device to which the data set is provided by the detection device wherein the evaluation device is configured to determine the status of the at least one component on the basis of the detected data set;
wherein the detection device is attached to the vehicle, wherein the detection device is positioned on the mover, wherein the detection device comprises a sensor that is based on a detection and/or emission of electro-magnetic waves and/or sound waves;
wherein the mover includes a carriage on the rail system; and
wherein the detection device and/or the mover includes a drive.

12. The commercial vehicle with a system according to claim 11, wherein the detection device is arranged on the vehicle so as to be mobile and/or pivotable and/or movable and/or changeable in location.

13. The commercial vehicle with a system according to claim 12, wherein the detection device is configured to detect a plurality of defined areas, and wherein each defined area comprises at least one component to be checked.

14. The commercial vehicle with a system according to claim 13, wherein the at least one component to be checked is part of a body or part of a chassis or part of a drive or part of a connection technology of the vehicle.

15. The commercial vehicle with a system according to claim 14, wherein the detection device is configured to check the state of the at least one component during a journey of the vehicle.

16. The commercial vehicle with a system according to one claim 15, wherein the data set can be stored in a memory device.

17. The commercial vehicle with a system according to claim 16, wherein the system comprises a communication device configured to transmit information relating to the status to a control centre.

18. The commercial vehicle with a system according to claim 17, wherein the communication device is in communication with a network.

19. The commercial vehicle with a system according to claim 17, wherein the detection devices are located in a closed area during a rest state.

20. The commercial vehicle with a system according to claim 11, wherein the detection device is configured to detect a plurality of defined areas, and wherein each defined area comprises at least one component to be checked.

21. The commercial vehicle with a system according to claim 11, wherein the at least one component to be checked is part of a body or part of a chassis or part of a drive or part of a connection technology of the vehicle.

22. The commercial vehicle with a system according to claim 11, wherein the detection device is configured to check the state of the at least one component during a journey of the vehicle.

23. The commercial vehicle with a system according to one claim 11, wherein the data set can be stored in a memory device.

24. The commercial vehicle with a system according to claim 11, wherein the system comprises a communication device configured to transmit information relating to the status to a control centre.

25. The commercial vehicle with a system according to claim 24, wherein the communication device is in communication with a network.

26. The commercial vehicle with a system according to claim 11, wherein the detection devices are located in a closed area during a rest state.

27. A method for determining a state of at least one component of a commercial vehicle having a system configured to check a state of at least one component on the commercial vehicle, comprising:
detecting of information in the form of a data set by a detection device, the information being present in a defined area on the vehicle, the defined area comprising the at least one component to be checked;
providing the data set to an evaluation device; and
determining the state of the component on the basis of the detected data set by the evaluation device, the detection device being fastened to the vehicle and positioned on a mover, wherein the detection device comprises a sensor based on the detection and/or emission of electromagnetic waves and/or sound waves;
wherein the mover includes a carriage on a rail system, wherein the detection device and/or the mover includes a drive, and wherein the detection device is positioned on an outside of the vehicle.

28. The method of claim 27, wherein the defined area is one of a plurality of defined areas.
